(19) United States
(12) Patent Application Publication
(10) Pub. No.: US 2005/0218329 A1
(43) Pub. Date: Oct. 6, 2005

(54) Tandem sensors for ultra sensitive and high resolution detection in a flow cell

(76) Inventor: Nathaniel Tue Tran, Irvine, CA (US)

Correspondence Address: NATHANIEL TUE TRAN, 3205 ASPEN GROVE, IRVINE, CA, 92618, US

(21) Appl. No.: 11/098,918

(22) Filed: Apr. 4, 2005

Related U.S. Application Data
(60) Provisional application No. 60/559,687, filed on Apr. 2, 2004.

(51) Int. Cl. G01N 21/00

(52) U.S. Cl. 250/356.1; 250/356.2

(57) ABSTRACT

A method of detection using a plurality of detectors placed along the flow path to detect the same fraction of sample multiple times. A computer program is used to integrate the reading results from these detectors together according to flow-rate. When the readings are added together, they are equal to one reading for a longer period of time (as if the sample is static) thus resulting in higher sensitivity for detection without scarifying any resolution. One application is to detect radioactivity and ratio of at least two radioactive isotopes in the flow-through medium in real-time. Another application is to detect and quantify time dependent event such as fluorescent resonance energy transfer to determine binding through molecular proximity, size of molecules through rate of rotation.

### CROSS REFERENCE TO RELATED APPLICATION

This application claims priority of provisional application U.S. Ser. No. 60/559687 filed Apr. 2, 2004 titled Tandem sensors for ultra sensitive and high resolution detection.

### FIELD OF THE INVENTION

This invention relates to flow-cells and sensors for detection used in biological and chemical analytical instrumentations.

### BACKGROUND OF THE INVENTION

Flow cell enable real-time detection of analytical events for fluidic experiments such as chromatography. A typical flow cell has one sensor for each type of detection. For example, a flow cell can detect ultraviolet absorbance and conductivity by having two separated sensors. However, each sensor only detects the passing through fraction of interest once. To improve sensitivity, the flow cell is usually make bigger such as having bigger detection unit such as long path for light to pass through as in UV/VIS/IR absorbance flow cell. However, the bigger path also lowers the reading resolution and may even allows sample intermixing resulting in lower separation resolution. Another way that path length can be increased is by bouncing the light beam back and forth between two mirrors in a zigzag fashion from the emitting source to the receiving detector. Such detection method is commonly used in gas chromatography. Since the zigzag of the beam spans over a lateral distance, larger fraction of sample is examined and reading resolution is still lower than detection using a single beam.

### SUMMARY OF THE INVENTION

Briefly, the invention provides a method of detection that allows a plurality of sensors to be placed along the flow path of a medium so that the same fraction of that medium can be read multiple times. The results from multiple-sensor readings are integrated together according to the flow rate. The outcome is much higher sensitive detection and measurement without reading sacrificing resolution.

The sensors setup are also designed to detect events that are better detected over a long time span such as radioactive decay, or other time dependent event such as fluorescent decay, fluorescent polarization, fluorescent resonant energy transfer . . . etc. within a flow-cell. Such flow-cell detection enables one to select only the fractions containing the molecules of interest in real-time.

The sensors are further improved to enable differential detection of radiation with different energy level such as those coming from ³H vs. ¹⁴C, or ³²P vs. ³²P . . . etc. These sensors use integrated electronics to distinguish radiation event from the different isotopes or use shielding of their scintillation materials to select different energy radiation.

An object of the invention is to provide a detection method with superior sensitivity and resolution for real time detection.

A further object of the invention is to provide a detection method for events not normally recordable using single sensor for recording at a single time point.

An additional object of the invention is to provide improve detection means for radiochromatography.

A further object of the invention is to provide a method of detection for time dependent events. The same portion of sample can be detected before and after a certain amount of time for comparison.

### DETAIL DESCRIPTION OF THE INVENTION

The invention teaches a method of real-time detection using multiple sensors placing along the flow path of a medium to record the same event over and over again as the medium passes through. The recording signals from different sensors are then integrated together by computer by taking into account the flow rate and sensors' locations to determine when the same portion of medium supposes to be exposed to a certain sensor. Simply stated, this type of flow-cell allows high resolution and higher sensitivity detection by detecting the same portion of medium sample over a longer period of time as it moves along. This flow cell also allows detection of a time-dependent event that can not be examined by normal flow cell.

Such a tandem sensor setup can be sensitive enough to detect radioactivity in flow-through medium in real time. Radioactive decay happens over time thus the longer the detection time, the more accurate and sensitive the detection can be. Small flow cells normally don't allow sufficient time for a detector to detect a meaningful amount of radioactive disintegration unless the flow-through medium contains a lot of radioactive material. Furthermore, with improvement is electronics, one can also detect the ratio of different radioactive isotopes in real time and fractionate the portions that have certain isotope ratio characteristic such as deviation in isotope ratio or sudden changes (slopes). Such fractionation is the corner stone of a method described in pending U.S. patent application Ser. No. 10/680277 titled Radioactive Multiplexing Analytical Methods, the content of which is incorporated herein as reference.

The sensors can differentially detect radiation from different radioactive isotope by differentiating between their radiation energy. For instance, a sensor can be engineered to detect weak radiation by having a thinner wall allowing weaker radiation to penetrate. Another sensor with thicker wall only detect strong radiation that can penetrate the thicker wall. When both sensors are used to detect radiation, the proportion of weak radiation and strong radiation can be found. Using empirical data from known proportion of weak radiation and strong radiation, one can generate a standard curve to calculate the actual ratio of the two isotopes if necessary.

Some radiation such as tritium's radiation is not strong enough to penetrate most solid mater. For these types of radiation, we use scintillation counting to conver beta radiation into light and quantify light as a measure of radiation. An alternative sensor design includes scintillation material to enhance the detection sensitivity of isotopes such as tritium. The scintillation material can be added directly to the fluid that flow through the flow cell or can be part of the sensor. The information from these sensors can be used to differentiate different radioactive isotopes by the integrating the detection pulse frequency spectrum. Stronger isotopes cause multiple scintillation events thus many photons are detected at once while weaker isotopes only generate limited number of photons. Such technology is known to those skilled in the art and has been used successfully in existing scintillation counters. The sensor can be solid state such as a simple photo detecting diode known to those skilled in the art in stead of the more bulky photo multiplying tube.

In addition to adding all detected events from multiple sensors together to improve sensitivity, the data from different sensors can also be analyzed independently for time dependent events such as fluorescent decay, fluorescent resonance transfer, fluorescent bleaching, and fluorescent polarization . . . etc. The medium can be excited once and then all the sensors down stream will detect sequential events. Some of these events are very useful in detecting molecules that bind to other molecules. For instance, fluorescent resonance energy transfer (FRET) is used to study the proximity of a known molecule usually with an engineer fluorochrome to another molecule. Close proximity can suggest direct or indirect interactions which are relevant to drug discovery. This type of detection thus enables selection of the molecules of interest for further study.

The entire sensors setup can be integrated on a single chip such as the current micro-fluidic devices. The fluid channel can zigzag through the chip or circle the chip to maximize path length. Each photon detector can be a simple diode or transistor gate junction activated by photons. The advances in semiconductor manufacturing have made manufacturing such a device possible and relatively affordable.

1. A method of detection comprising of at least two sensors each detecting the same quality of a flow-through medium at:
(a) a unique place along the flow path; and
(b) a unique time point.

2. The method of detection of claim 1 wherein data from said sensors are integrated together according to:
(a) the flow volume between said sensors; and
(b) the flow-rate of said flow-through medium.

3. The method of detection of claim 1 wherein data from one sensor is compared to data from another sensor to evaluate a time dependent event.

4. The method of detection of claim 1 wherein said quality is radioactive decay.

5. The method of detection of claim 1 wherein said quality is fluorescent emission.

6. The method of claim 1 wherein said sensors are capable of distinguishing radiations from different radioactive isotope due to their differences in radiation energy.

7. A method of detecting a time-delayed event at multiple points along the flow path of a medium.

8. The method of claim 7 wherein said time-delayed event is radioactive decay.

9. The method of claim 7 wherein said time-delayed event is fluorescent resonance energy transfer.

10. The method of claim 7 wherein said time-delayed event is fluorescent polarization.

11. The method of claim 7 wherein said time-delayed event is phosphorescence.

12. The method of claim 7 wherein said time-delayed event is fluorescent decay.

13. The method of claim 7 wherein said time-delayed event is a scintillation event.

14. A flow cell detector for radiochromatography comprising of:
(a) a plurality of sensors along a flow path of a medium.
(b) an integrator capable of integrating signals from said plurality of sensors together.
